(19) United States
(12) Patent Application Publication
(10) Pub. No.: US 2022/0002163 A1
(43) Pub. Date: Jan. 6, 2022

(54) PRECURSOR MATERIAL FOR THE PRODUCTION OF SILICON CARBIDE CONTAINING MATERIALS

(71) Applicant: PSC Technologies GmbH, Beriin (DE)

(72) Inventors: Siegmund GREULICH-WEBER, Bad Lippspringe (DE); Paul KNAPPE, Berlin (DE); Rüdiger SCHLEICHER-TAPPESER, Berlin (DE)

(21) Appl. No.: 17/291,505

(22) PCT Filed: Nov. 6, 2019
(86) PCT No.: PCT/EP2019/080382

§ 371 Date: May 5, 2021

(51) Int. Cl. C01B 32/977

(52) U.S. Cl. CPC C01B 32/977; C01P 2004/62; C01P 2004/61

(57) ABSTRACT

The invention relates to a method for the production of a composition, in particular a SiC precursor granulate, for use in additive manufacturing from a solution or dispersion.

The present invention relates to the technical field of the production of silicon carbide-containing materials, in particular by means of additive manufacturing.

In particular, the present invention relates to a method for the production of a composition, in particular a precursor granulate, which is suitable for the production of silicon carbide-containing materials and, more particularly, for the production of three-dimensional objects from silicon carbide-containing materials in additive manufacturing processes.

The present invention further relates to a composition, in particular a precursor granulate, for the production of silicon carbide-containing materials.

Furthermore, the present invention relates to a composition, in particular a precursor granulate, for use in generative manufacturing processes.

Furthermore, the present invention relates to a liquid composition, in particular a suspension, containing a precursor granulate.

Furthermore, the present invention relates to the use of a composition, in particular a precursor granulate, for the production of silicon carbide-containing materials or in generative manufacturing processes for the production of three-dimensional objects from silicon carbide-containing materials.

Generative manufacturing processes, also known as additive manufacturing (AM), are methods for the rapid production of models, patterns, tools and products from formless materials such as liquids, gels, pastes or powders.

Originally, the term 3D printing or rapid prototyping was generally used for the entire technical field of generative manufacturing processes. However, these terms are now only used for special embodiments of generative manufacturing processes. Generative manufacturing processes are used for the production of objects from inorganic materials, in particular metals and ceramics, as well as from organic materials.

High-energy methods, such as selective laser melting (SLM), electron beam melting or deposition welding, are preferably used for the production of objects from inorganic materials, since the reactants or precursors used only react or melt at higher energy input.

In principle, additive manufacturing enables the rapid production of highly complex components, but in particular the production of components from inorganic materials poses a number of challenges for both the reactant and the product materials: for example, the reactants must react in a specified manner under the action of energy, and in particular disruptive side reactions need to be excluded. In addition, for example, no segregation of the products or phase separation or decomposition of the products may occur under the influence of energy.

An extremely interesting material with a wide range of applications, both for components subject to high mechanical stress and for semiconductor applications, is silicon carbide, also known as carborundum. Silicon carbide, with the chemical formula SiC, has an extremely high hardness as well as a high sublimation point and is frequently used as an abrasive or as an insulator in high-temperature reactors. Silicon carbide also forms alloys or alloy-like compounds with a variety of elements and compounds, which have a number of advantageous material properties, such as high hardness, high durability, low weight and low oxidation sensitivity even at high temperatures.

Silicon carbide-containing materials are usually obtained by sintering processes from reactants or reactant mixtures containing silicon carbide particles. However, relatively porous bodies are obtained, which are only suitable for a limited number of applications.

The properties of the porous silicon carbide material produced via conventional sintering processes do not match those of compact crystalline silicon carbide, so that the advantageous properties of silicon carbide cannot be fully exploited.

Another complicating factor is that silicon carbide does not melt at high temperatures—depending on the respective crystal type—in the range between 2,300 and 2,700° C., but sublimates, i.e. changes from the solid to the gaseous aggregate state. Silicon carbide is therefore unsuitable as the sole starting material for additive manufacturing, in particular for methods such as laser melting. Due to the versatility of silicon carbide and its many positive application properties, attempts have nevertheless been made to process silicon carbide by means of additive manufacturing processes.

For example, DE 10 2015 105 085.4 describes a method for the production of bodies from silicon carbide crystals, wherein the silicon carbide is obtained in particular by laser irradiation from suitable precursor compounds containing carbon and silicon. Under the action of the laser beam, the precursor compounds decompose selectively and silicon carbide is formed without the silicon carbide subliming.

The method described in DE 10 2015 105 085.4 is quite suitable for obtaining silicon carbide objects, but the reproducible preparation of the precursor material, which is obtained via a sol-gel process, is tedious and costly. On the one hand, the aging of the compounds used from a sol to a gel is very time-consuming, and on the other hand, the precursor material obtained by the sol-gel method must still be subjected to a reductive thermal treatment, in particular a carbothermal treatment, at about 1,100° C. in order to reproducibly obtain precursor materials with consistently good properties for additive manufacturing. The product obtained following the sol-gel method by simple drying comprises changing compositions and can only be converted into a stable and reproducible form by reductive thermal treatment at but high temperatures.

In addition, methods for the production of silicon carbide-containing materials, in particular silicon carbide crystals or fibers, which are obtained by deposition from the gas phase are also known.

Such a method is described, for example, in DE 10 2015 100 062 A1. A precursor granulate is again used as the starting material, which is obtained in a complex sol-gel process and is then subjected to a thermal treatment at over 1,000° C.

The prior art thus lacks a convenient method for providing suitable compositions, in particular precursor granulates, for the production of silicon carbide-containing materials, which can be processed to silicon carbide-containing materials in particular in additive manufacturing processes, especially powder bed processes.

An object of the present invention is therefore to eliminate the above-mentioned disadvantages associated with the prior art, or at least to mitigate them.

In particular, one object of the present invention is to provide a simplified method for the production of a composition, in particular a precursor granulate, which can be used in the additive manufacturing of objects made of silicon carbide-containing materials.

A further object of the present invention is to provide a precursor granulate which can be produced reproducibly in consistent quality at minimum cost.

Consequently, the subject-matter of the present invention according to a first aspect of the present invention is a method for the production of a composition, in particular a precursor granulate, according to claim 1; further, advantageous embodiments of this aspect of the invention are subject of the respective dependent claims.

In addition, subject-matter of the present invention according to a second aspect of the present invention is a composition, in particular a precursor granulate according to claim 16.

Again, further subject-matter of the present invention according to a third aspect of the present invention is a liquid composition according to claim 17.

Furthermore, subject-matter of the present invention according to a fourth aspect of the present invention is the use of a composition according to claim 18.

Finally, further subject-matter of the present invention according to a fifth aspect of the present invention is the use of a composition, in particular a precursor granulate, according to claim 19.

It goes without saying that special embodiments mentioned below, in particular special configurations or the like, which are described only in the context of one aspect of the invention, also apply accordingly with respect to the other aspects of the invention, without this requiring express mention.

Furthermore, in the case of all relative or percentage, in particular weight-related, indications of quantity mentioned below, it should be noted that, in the context of the present invention, these are to be selected by the person skilled in the art in such a way that, in the sum of the ingredients, additives or auxiliaries or the like, 100% or wt. % always results. However, this is self-evident for the person skilled in the art

In addition, all the parameter specifications or the like mentioned below can in principle be determined or ascertained using standardized or explicitly specified determination methods or using determination methods familiar to the person skilled in the art

With this proviso stated, the subject-matter of the present invention will be explained in more detail below.

Thus, subject-matter of the present invention—according to a first aspect of the present invention—is a method for the production of a composition, in particular of a SiC precursor granulate, wherein

(a) in a first method step, a solution or dispersion, in particular a sol, containing the components
(i) at least one silicon-containing compound,
(ii) at least one carbon-containing compound,
(iii) at least one solvent or dispersant, and
(iv) optionally doping and/or alloying reagents,
is produced, and

(b) in a second method step following the first method step (a), the solvent or dispersant is removed.

As the applicant has surprisingly found, a defined composition, in particular a SiC precursor granulate, can be reproducibly obtained by homogenizing or dissolving the individual components or reactants of the composition or the SiC precursor granulate in a solution or dispersion, preferably a colloidal solution or a sol, and then rapidly removing the solvent or dispersant It has been shown that aging of the colloidal solution or sol to form a gel is not necessary, but that after production of a solution or dispersion, in particular a sol, the solvent or dispersant can and should preferably be removed rapidly.

With the method according to the invention, it is in particular possible to reproducibly produce SiC precursor granules that are precisely defined in terms of their chemical composition, without the precursor granules having to be subjected to a complex thermal treatment at temperatures of over 1,000° C.

The method according to the invention thus represents a significant simplification compared to the previous production of compositions, in particular SiC precursor granules, for the additive manufacturing of silicon carbide-containing bodies. In particular, the method according to the invention brings significant time and energy savings, which can considerably reduce the cost of manufacturing the composition, in particular the precursor granulate.

In the context of the present invention, it is provided in particular that the composition, in particular the precursor granulate, is not a powder mixture, in particular not a mixture of different precursor powders and/or granules. It is a particular feature of this method that a homogeneous granulate, in particular a precursor granulate, is used as the starting material for additive manufacturing. In this way, by means of short exposure times to energy, in particular to laser radiation, the composition, in particular the precursor granulate, can pass into the gas phase or the precursor compounds can react to form the desired target compounds, wherein it is not necessary to sublimate individual particles of different inorganic substances with particle sizes in the μm range, the constituents of which must then diffuse to form the corresponding compounds and alloys. As a result of the homogeneous composition obtained in the context of the present invention, in particular the precursor granules, the individual building blocks, in particular elements, of the silicon carbide-containing target compound are homogeneously distributed and arranged in close proximity to one another, i.e. less energy is required for the production of the silicon carbide-containing compounds.

In this way, a homogeneous distribution of the individual components, in particular precursor compounds, in the composition, in particular the granules, can be achieved, wherein preferably the stoichiometry of the silicon carbide-containing material to be produced is already preformed.

Moreover, the precursor granulate obtainable by the method according to the invention is suitable for the production of a wide variety of silicon carbide-containing materials. In particular, the precursor granulate obtainable by the method according to the invention can be used in all methods in which silicon carbide-containing materials are obtained either from precursor compounds and/or by vapor deposition. The method according to the invention always provides a simple, inexpensive and reproducible way to obtain suitable starting materials.

In the context of the present invention, a solution is to be understood as a single-phase system in which at least one substance, in particular a compound or its constituents, such as ions, are homogeneously distributed in a further substance, the solvent.

In the context of the present invention, a dispersion is to be understood as an at least two-phase system, wherein a first phase, namely the dispersed phase, is present distributed in a second phase, the continuous phase. The continuous phase is also referred to as a dispersion medium or dispersant

A colloidal solution or sol is understood to be a solution or finely divided dispersion, which preferably comprises particles with a particle diameter of 1 to 1,000 nm. In particular in the case of sols or colloidal solutions or also polymeric compounds, in which macromolecules are finely distributed in the solvent or dispersant, the transition between a solution and a dispersion is often fluid, so that it is no longer possible to distinguish clearly between a solution or a dispersion. When silicon dioxide is used as a silicon-containing compound, it may be envisaged that the solution or dispersion, in particular the sol, comprises particles with a particle diameter of more than 1,000 nm. However, it is more preferably, even in this case, if the diameter of the silica particles is less than 1,000 nm. This can be achieved, for example, by using fumed silica, which usually comprises primary particles with particle diameters in the range of 5 to 50 nm and agglomerates with diameters of 100 is 400 nm, or by using silica sol. The particle sizes can be determined, for example, by means of dynamic light scattering.

The method according to the invention can be used to provide a wide range of precursors for silicon carbide-containing materials. In the context of the present invention, a silicon carbide-containing compound means a binary, ternary or quaternary inorganic compound or alloy whose molecular formula contains silicon and carbon. In particular, a silicon carbide-containing compound in the context of the present invention does not contain molecularly bound carbon, such as carbon monoxide or carbon dioxide; rather, the carbon is present in a solid-state structure.

As previously disclosed, the method for the production of precursor materials according to the present invention is suitable for a wide range of silicon carbide-containing compounds. In the context of the present invention, the silicon carbide-containing compound is thereby usually selected from optionally doped silicon carbide, non-stoichiometric silicon carbides and silicon carbide alloys. In the context of the present invention, a non-stoichiometric silicon carbide compound is understood to be a silicon carbide which does not contain carbon and silicon in the molar ratio 1:1, but in ratios deviating therefrom. Typically, a non-stoichiometric silicon carbide in the context of the present invention comprises a molar excess of silicon.

In the context of the present invention, silicon carbide alloys are compounds of silicon carbide with metals, such as titanium or other compounds, such as zirconium carbide or boron nitride, which contain silicon carbide in varying and highly fluctuating proportions.

Silicon carbide alloys often form high-performance ceramics or stoichiometric compounds, which are characterized by a particular hardness and temperature resistance.

The composition according to the invention can be used in a wide range of variations and is suitable for the production of a large number of different silicon carbide compounds, in particular for the specific adjustment of their mechanical properties.

If in the context of the present invention a non-stoichiometric silicon carbide is produced, the non-stoichiometric silicon carbide is usually a silicon carbide of the general formula (I)

SiC₁₋ₓ (I)

with

x=0.05 to 0.8, in particular 0.07 to 0.5, preferably 0.09 to 0.4, more preferably 0.1 to 0.3.

Such silicon-rich silicon carbides have particularly high mechanical strength and are suitable for a variety of applications as ceramics.

When the silicon carbide-containing compound produced in the present invention is a silicon carbide alloy, the silicon carbide alloy is typically selected from MAX phases, alloys of silicon carbide with elements, in particular metals, and alloys of silicon carbide with metal carbides and/or metal nitrides. Such silicon carbide alloys contain silicon carbide in varying and strongly fluctuating proportions. In particular, it may be envisaged that silicon carbide constitutes the main constituent of the alloys. However, it is also possible that the silicon carbide alloy contains silicon carbide only in small amounts.

Typically, the silicon carbide alloy comprises the silicon carbide in amounts of 10 to 95 wt. %, in particular 15 to 90 wt. %, preferably 20 to 80 wt %, based on the silicon carbide alloy.

In the context of the present invention, a MAX phase means in particular carbides and nitrides crystallizing in hexagonal layers of the general formula Mₙ₊₁AXₙ with n=1 to 3. M stands for an early transition metal from the third to sixth group of the periodic table of the elements, while A stands for an element from the 13th to 16th group of the periodic table of the elements. Finally, Xis either carbon or nitrogen. In the context of the present invention, however, only those MAX phases are of interest whose molecular formula contains silicon carbide (SiC), i.e. silicon and carbon.

MAX phases comprise unusual combinations of chemical, physical, electrical and mechanical properties, as they exhibit both metallic and ceramic behavior, depending on the conditions. This includes, for example, high electrical and thermal conductivity, high resistance to thermal shock, very large hardnesses, and low coefficients of thermal expansion.

When the silicon carbide alloy is a MAX phase, it is preferred if the MAX phase is selected from Ti₄SiC₃ and Ti₃SiC.

In particular, the aforementioned MAX phases are highly resistant to chemicals as well as oxidation at high temperatures, in addition to the properties already described.

When the silicon carbide containing compound is an alloy of silicon carbide, in case the alloy is an alloy of silicon carbide with metals, it has been well proven when the alloy is selected from alloys of silicon carbide with metals from the group of Al, Ti, V, Cr, Mn, Co, Ni, Zn, Zr and mixtures thereof.

If the alloy of silicon carbide is selected from alloys of silicon carbide with metal carbides and/or nitrides, it has been well proven if the alloys of silicon carbide with metal carbides and/or nitrides are selected from the group of silicon carbide with boron carbides, in particular B₄C, chromium carbides, in particular Cr₂C₃, titanium carbides, in particular TiC, molybdenum carbides, in particular Mo₂C, niobium carbides, in particular NbC, tantalum carbides, in particular TaC, vanadium carbides, in particular VC, zirconium carbides, in particular ZrC, tungsten carbides, in particular WC, boron nitride, in particular BN, and mixtures thereof.

In the context of the present invention, it is usually provided that in the second method step (b) a powdery composition is obtained. By being present in the form of a powdery composition, in particular a precursor granulate, it becomes possible to use the composition in powder bed processes for the production of silicon carbide-containing objects.

In the context of the present invention, particularly good results are obtained when the powdery composition comprises particle sizes in the range of 0.5 μm to 1,000 μm, in particular 0.5 μm to 500 μm, preferably 1 μm to 200 μm, more preferably 10 μm to 100 μm, particularly preferably 40 μm to 80 μm.

Similarly, in the context of the present invention, very good results are obtained when the particles of the precursor granulate comprise a D₆₀ value in the range of 1 to 500 μm, in particular 2 to 100 μm, preferably 12 to 80 μm, more preferably 40 to 75 μm. The D60 value for the particle size represents the limit below which the particle size comprises 60% of the particles of the composition, i.e. 60% of the particles of the composition comprise particle sizes smaller than the D₆₀ value.

Equally, however, it may also be envisaged that the composition comprises a bimodal particle size distribution. In this way, compositions with a high bulk density are in particular accessible.

Turning now to the silicon-containing compound, it has been well proven if the silicon carbide-containing compound is selected from silanes, silane hydrolysates, orthosilicic acid, silicon dioxide as well as mixtures thereof, preferably silanes, silicon dioxide and mixtures thereof.

In the context of the present invention, the use of silanes, or silane hydrolysates and orthosilicic acid, is a preferred embodiment, since these can rapidly convert the aforementioned compounds into silica derivatives without leaving any low-volatility organic residues. In this way, the stoichiometry is readily adjustable with respect to the silicon-containing compound of the resulting composition and also of the silicon carbide-containing compound obtainable with it. For example, by co-hydrolysis with further precursors, in particular for doping or alloying elements, tailor-made compositions suitable for the production of specific silicon carbide-containing compounds can be obtained. The use of silanes is particularly preferred in this context.

In addition, it has been shown that silicon dioxide is often also used directly as a silicon-containing compound, in particular in finely divided form. More preferably, silicon dioxide is used in the form of oligomeric or polymeric silicic acid. Particularly good results are obtained if the oligomeric or polymeric silicic acid is selected from precipitated silica, silica gel, silica sol, fumed silica and mixtures thereof, preferably silica sol, fumed silica and mixtures thereof. Particularly good results are obtained in this context if the oligomeric or polymeric silica is fumed silica, preferably hydrophilic fumed silica.

If in the context of the present invention a silane is used, it has been well proven if the silane is selected from silanes of the general formula II

R₄₋ₙSiXₙ (II)

with

R=alkyl, in particular C₁- to C₅-alkyl, preferably C₁- to C₃-alkyl, more preferably C₁- and/or C₂-alkyl;
aryl, in particular C₆- to C₂₀-aryl, preferably C₆- to C₁₀-aryl, more preferably C₆- to C₁₀-aryl;
olefin, in particular terminal olefin, preferably C₂- to C₁₀-olefin, preferably C₂- to C₈-olefin, more preferably C₂- to C₅-olefin, particularly preferably C₂- and/or C₃-olefin, particularly preferred vinyl;
amine, in particular C₂- to C₁₀-amine, preferably C₂- to C₈-amine, more preferably C₂-to C₅-amine, particularly preferably C₂- and/or C₃-amine;
carboxylic acid, in particular C₂- to C₁₀-carboxylic acid, preferably C₂- to C₈-carboxylic acid, more preferably C₂- to C₅-carboxylic acid, particularly preferably C₂- and/or C₃-carboxylic acid;
alcohol, in particular C₂- to C₁₀-alcohol, preferably C₂- to C₈-alcohol, more preferably C₂- to C₅-alcohol, particularly preferably C₂- and/or C₃-alcohol;

X=halide, in particular chloride and/or bromide;
alkoxy, in particular C₁- to C₆-alkoxy, more preferably C₁- to C₄-alkoxy, particularly preferably C₁- and/or C₂-alkoxy; and

n=1-4, preferably 3 or 4.

Particularly good results are obtained when the silane is selected from silanes of the general formula IIa

R₄₋ₙSiXₙ (IIa)

with

R=C₁- to C₃-alkyl, in particular C₁- and/or C₂-alkyl;
C₆- to C₁₅-aryl, in particular C₆- to C₁₀-aryl;
C₂- and/or C₃-olefin, in particular vinyl;

X=alkoxy, in particular C₁- to C₆-alkoxy, more preferably C₁- to C₄-alkoxy, particularly preferably C₁- and/or C₂-alkoxy; and

n=3 or 4.

In this context, it is particularly preferred if the silane is selected from tetraalkoxysilanes and/or trialkoxyalkylsilanes, preferably tetraethoxysilane. Particularly preferably in this context, the silane is selected from tetraethoxysilane, tetramethoxysilane or triethoxymethylsilane, wherein tetraethoxysilane is used more preferably.

Now, as to the amount in which the solution or dispersion contains the silicon-containing compound, this can vary over a wide range. Usually, in the first method step (a), the solution or dispersion contains the silicon-containing compound in amounts of 5 to 40 wt. %, in particular 10 to 30 wt. %, preferably 15 to 25 wt %, more preferably 17 to 20 wt. %, based on the solution or dispersion.

Similarly, it may be provided that the solution or dispersion in the first method step (a) contains the silicon-containing compound in a molar fraction of 1 to 25%, in particular 2 to 20%, preferably 3 to 15%, more preferably 4 to 10%, particularly preferably 5 to 10%, based on the total molar amount of the solution or dispersion.

Furthermore, it may be provided in the context of the present invention that for the production of the solution or dispersion in the first method step (a) at least one of the components is heated to temperatures in the range of 30 to 100° C., preferably 40 to 80° C., more preferably 50 to 70° C.

More preferably, in the context of the present invention, the solution or dispersion is heated at least temporarily to the aforementioned temperatures during the production process. Due to the temperature increase, a rapid dissolution or fine-particle dispersion of the individual components in the dissolving or dispersing agent is given and also a possible hydrolysis of, for example, silanes or doping and alloying reagents takes place much more rapidly.

According to a more preferred embodiment of the present invention, the solvent or dispersant is heated, in particular to temperatures in the range from 20° C. below, preferably 10° C. below, the boiling point of the solvent or dispersant to the boiling point of the solvent or dispersant.

Now, with regard to the amount in which the solution or dispersion contains the solvent or dispersant, it has been well proven if the solution or dispersion contains the solvent or dispersant in amounts of 20 to 80 wt. %, in particular 30 to 70 wt %, preferably 40 to 60 wt. %, more preferably 45 to 55 wt %, based on the solution or dispersion.

Similarly, it may be provided in the context of the present invention that the solution or dispersion contains the solvent or dispersant in a molar fraction of 40 to 95%, in particular 50 to 90%, preferably 60 to 90%, more preferably 70 to 90%.

Generally, the solvent or dispersant is selected from water, organic solvents and mixtures thereof.

If the solvent or dispersant is selected from organic solvents or from mixtures of water and organic solvents, it has been well proven if the solvent is selected from alcohols, esters, ketones, amines, amides, sulfoxides and mixtures thereof, in particular methanol, ethanol, 2-propanol, acetone, ethyl acetate, N,N-dimethylformamide, dimethyl sulfoxide and mixtures thereof. Particularly good results are obtained when the organic solvent is selected from alcohols, in particular methanol, ethanol and 2-propanol. Ethanol is preferred due to its relatively high volatility and low toxicity.

According to a more preferred embodiment of the present invention, the solvent or dispersant is a mixture of water and at least one organic solvent. Particularly good results are obtained in this context if the solvent or dispersant is a mixture of water and an alcohol, in particular methanol, ethanol and 2-propanol, preferably ethanol.

When water is present in the solvent or dispersant, rapid hydro- or solvolysis of silanes or also doping and alloying reagents, in particular salt-type doping and alloying reagents, is given.

If the solvent or dispersant is a mixture of water and at least one organic solvent, it has been well proven if the solvent or dispersant comprises a ratio by weight of water to organic solvents in the range from 4:1 to 1:10, in particular 2:1 to 1:8, preferably 1:1 to 1:5, preferably 1:1 to 1:3.

Similarly, very good results are obtained if the solvent or dispersant comprises a substance ratio of water to organic solvents in the range of 10:1 to 1:5, in particular 8:1 to 1:2, preferably 5:1 to 1:1, preferably 2:1 to 1:1.

According to a more preferred embodiment of the present invention, when silica is used as the silicon-containing compound, it may be provided that water is used as the sole solvent or dispersant

Now, as far as the carbon-containing compound is concerned, its content in the solution or dispersion in the first method step (a) may vary in a wide range. Usually, the solution or dispersion comprises the carbon-containing compound in amounts of 1 to 50 wt. %, in particular 5 to 40 wt. %, preferably 8 to 30 wt %, more preferably 10 to 25 wt. %, particularly preferably 12 to 20 wt %, based on the solution or dispersion.

Now, as far as the chemical composition of the carbon-containing compound is concerned, this is usually selected from sugars, in particular sucrose, glucose, fructose, invert sugar, maltose; starch; starch derivatives; organic polymers, in particular phenol-formaldehyde resin and resorcinol-formaldehyde resin, and mixtures thereof.

Particularly good results are obtained in this context when the carbon-containing compound is selected from the group consisting of sugars, starches, starch derivatives and mixtures thereof, more preferably sugars.

In the context of the present invention, it may be provided, as previously set forth, that the solution or dispersion contains at least one doping and/or alloying reagent. If the solution comprises a doping and/or alloying reagent, it has been well proven if the solution or dispersion comprises the doping or alloying reagent in amounts of 0.000001 to 60 wt %, in particular 0.000001 to 45 wt %, preferably 0.000005 to 45 wt %, more preferably 0.00001 to 40 wt %, based on the solution or dispersion.

If the solution or dispersion comprises a doping reagent, the solution or dispersion typically comprises the doping reagent in amounts of 0.000001 to 0.5 wt %, preferably 0.000005 to 0.1 wt %, more preferably 0.00001 to 0.01 wt. %, based on the solution or dispersion.

If the solution or dispersion contains an alloying reagent, it is usually provided that the solution or dispersion contains the alloying reagent in amounts of 5 to 60 wt. %, in particular 10 to 45 wt. %, preferably 15 to 45 wt %, more preferably 20 to 40 wt. %, based on the solution or dispersion.

Turning now to the chemical nature of the doping reagent, it may be selected from suitable doping elements. Preferably, the doping reagent or doping element is selected from elements of the third and fifth main groups of the periodic table. Preferably, the doping reagent is selected from compounds of an element of the third or fifth main group of the periodic table of elements, which are soluble in the solvent or dispersant. The doping reagent is usually selected from nitric acid, ammonium chloride, melamine, phosphoric acid, phosphonic acids, boric acid, borates, boron chloride, indium chloride and mixtures thereof.

If doping with nitrogen is provided, the solution may contain nitric acid, ammonium chloride or melanin. If doping with phosphorus is provided, phosphoric acid or phosphates or phosphonic acids may be used, for example.

If doping with boron is provided, boric acids, borates or boron salts, such as boron trichloride, are used, for example.

If doping with indium is provided, water-soluble indium salts, such as indium chloride, are typically used as the doping reagent

In the context of the present invention, if the solution or dispersion contains an alloying reagent, the alloying reagent is usually selected from compounds of Al, Ti, V, Cr, Mn, Co, Ni, Zn, Zr and mixtures thereof soluble in the solvent or dispersant According to a more preferred embodiment of the present invention, the alloying reagent is selected from chlorides, nitrates, acetates, acetylacetonates and formates of Al, Ti, V, Cr, Mn, Co, Ni, Zn, Zr and mixtures thereof.

Furthermore, it may be provided in the context of the present invention that the solution or dispersion contains at least one catalyst The catalyst is in particular present as component (v) in the solution or dispersion in the first method step (a). The catalyst is intended to accelerate the solvolysis or hydrolysis of the components used so that they form a solution or homogeneous dispersion as quickly as possible. When silica is used as the silicon-containing compound, the use of a catalyst can usually be omitted unless the catalyst is to be used to accelerate the solvolysis or hydrolysis of doping or alloying reagents.

In the context of the present invention, it is preferably the case that the catalyst is an acid or base, preferably an acid. In particular, the acids and bases used are Bronsted acids and bases.

Particularly good results are obtained when the acid is selected from the group of carboxylic acids, mineral acids and mixtures thereof.

Particularly preferably in the context of the present invention is the use of carboxylic acids, such as acetic acid, oxalic acid, citric acid, fumaric acid, fatty acids, especially citric acid.

The amount in which the solution or dispersion contains the catalyst can naturally vary over a wide range. However, it has been well proven in the context of the present invention if the solution or dispersion comprises the catalyst in amounts of 0.1 to 10 wt. %, in particular 0.5 to 7 wt %, preferably 1 to 5 wt. %, more preferably 2 to 4 wt %, based on the solution or dispersion. With catalyst amounts in the aforementioned ranges, rapid hydrolysis of the starting compounds used can be ensured.

In the context of the present invention, it is preferred if the second method step (b) is carried out immediately after the first method step (a). In particular, it is preferred in the context of the present invention if the second method step is carried out prior to gel formation, for example from hydrolyzed silanes. This is because, as previously stated, the applicant has surprisingly found out that the production of a solution or homogeneous finely divided dispersion, in particular a sol, of the components used is sufficient to obtain an excellent precursor granulate after removal of the solvent or dispersant In particular, it was found out that the gel formation practiced so far leads to significantly worse results, in particular, in addition to the longer reaction time due to gel formation, the work-up and isolation of a defined precursor granulate is also significantly more difficult and costlier.

In the context of the present invention, it is in particular preferred if the second method step (b) is carried out at the latest 30 minutes, preferably at the latest 15 minutes, after completion of the first method step (a).

Now, as far as the duration of the first method step (a) is concerned, this can vary within wide ranges. Usually, the production of the solution or dispersion in method step (a) is carried out by simultaneous or successive mixing of the individual components over a period of 1 min to 2 h, in particular 10 min to 1.5 h, preferably 15 min to 1 h.

Within the scope of the present invention, it has been well proven if in the second method step (b) the solvent or dispersant is removed at an elevated temperature and/or under reduced pressure. Particularly preferably, in the context of the present invention, the solvent or dispersant is removed at an elevated temperature and under reduced pressure, for example in the course of a vacuum distillation. An increase in temperature or a reduction in pressure is advantageous, since this ensures faster removal of the solvent or dispersant, and thus gel formation can be reliably avoided.

According to a particular and preferred embodiment of the present invention, it is provided that in a third method step (c) following the second method step (b), the composition obtained in the second method step (b) is subjected to a thermal treatment, in particular a reductive thermal treatment. Preferably, a reduced composition is obtained in this way. The reductive thermal treatment allows a more compact precursor granulate to be obtained, with which greater layer thicknesses can be produced in additive manufacturing.

The reductive thermal treatment typically takes place under an inert gas atmosphere, wherein in particular the carbon source, preferably a sugar-based carbon source, reacts with oxides or other compounds of silicon as well as any additional compounds of other elements, thereby reducing the elements and producing volatile oxidized carbons and hydrogens, in particular water and CO₂, which are removed via the gas phase.

When the composition is subjected to thermal treatment in a third method step (c), the composition in the third method step (c) is usually heated to temperatures in the range of 300 to 900° C., in particular 400 to 800° C., preferably 500 to 700° C. Here again, a significant difference from the previous production of the precursor granulate for the sol-gel process becomes apparent: In the method according to the invention, significantly lower temperatures are required for the production of a reduced precursor granulate, which in the case of the sol-gel process are in the range of about 1,100° C.

By thermal treatment, in particular reductive thermal treatment, it is possible to obtain a precursor granulate with significantly higher density. This precursor granulate with increased density is also referred to hereinafter as reduced precursor granulate or reduced composition. In particular, the density of the composition after method step (c) is increased by about 8 to 30%, in particular 10 to 20%, compared with the product obtained in method step (b). By using the reduced composition or the reduced precursor granulate, it is possible to significantly increase the layer thickness of the silicon carbide-containing material produced in the course of powder bedding processes or methods similar to deposition welding and to obtain compact, i.e. non-porous, materials.

Furthermore, within the scope of the present invention, it is possible to obtain a defined composition or a defined precursor granulate in a reproducible manner even without the reductive thermal treatment, i.e. already following the second method step (b).

If a third method step (c) is carried out in the method according to the invention, the third method step (c) is usually carried out under a protective gas atmosphere, in particular under a nitrogen or argon atmosphere, or in a vacuum.

As previously stated, it is possible within the scope of the present invention to obtain a variety of silicon carbide-containing materials from the composition, in particular the precursor granulate. If different silicon carbide-containing materials, such as non-stoichiometric silicon carbide or silicon carbide alloys, are to be obtained, different preferred embodiments of the composition and method according to the present invention will result in each case.

If, in the context of the present invention, a stoichiometric silicon carbide SiC, which is optionally doped, is to be obtained, particularly good results are obtained if the solution or dispersion in the first method step contains the silicon-containing compound in amounts of 10 to 40 wt %, in particular 12 to 30 wt. %, preferably 15 to 25 wt %, more preferably 17 to 20 wt. %, based on the solution or dispersion.

Similarly, according to this embodiment, it may be provided that the solution or dispersion comprises the carbon-containing compounds in amounts of 6 to 40 wt. %, in particular 8 to 30 wt. %, preferably 10 to 25 wt. %, more preferably 12 to 20 wt %, based on the solution or dispersion.

Furthermore, in accordance with this embodiment, it may be provided that the solution or dispersion comprises the solvent or dispersant in amounts of 20 to 80 wt %, in particular 30 to 70 wt. %, preferably 40 to 60 wt. %, preferably 45 to 55 wt. %, based on the solution or dispersion.

If the silicon carbide is to be doped, the solution or dispersion typically contains the doping reagent in amounts of 0.000001 to 0.5 wt. %, preferably 0.000005 to 0.1 wt %, more preferably 0.00001 to 0.01 wt %, based on the solution or dispersion.

If, in the context of the present invention, a non-stoichiometric silicon carbide is to be obtained, in particular with a molar excess of silicon, it has been well proven if the solution or dispersion in the first method step (a) contains the silicon-containing compound in amounts of 12 to 40 wt. %, in particular 15 to 40 wt. %, preferably 18 to 35 wt. %, particularly preferably 20 to 30 wt %, based on the solution or dispersion.

According to this embodiment, it may further be provided that the solution or dispersion comprises the carbon-containing compound in amounts of 6 to 40 wt. %, in particular preferably 8 to 30 wt. %, preferably 10 to 25 wt %, more preferably, 12 to 20 wt %, based on the solution or dispersion.

Furthermore, in accordance with this embodiment, it may equally be provided that the solution or dispersion comprises the solvent or dispersant in amounts of 20 to 80 wt %, in particular 30 to 70 wt. %, preferably 40 to 60 wt %, more preferably 45 to 55 wt. %, based on the solution or dispersion.

If the non-stoichiometric silicon carbide is to be doped, it has been well proven if the solution or dispersion contains the doping reagent in amounts of 0.000001 to 0.5 wt. %, preferably 0.000005 to 0.1 wt %, more preferably 0.00001 to 0.01 wt. %, based on the solution or dispersion.

If a silicon carbide alloy is to be produced in the context of the present invention, it has been well proven if the solution or dispersion in the first method step (a) contains the silicon-containing compound in amounts of 5 to 30 wt. %, in particular 6 to 25 wt. %, preferably 8 to 20 wt. %, more preferably 10 to 20 wt %, based on the solution or dispersion.

Similarly, according to this embodiment, it is preferred if the solution or dispersion comprises the carbon-containing compound in amounts of 5 to 40 wt. %, in particular 6 to 30 wt. %, preferably 7 to 25 wt %, more preferably, 10 to 20 wt %, based on the solution or dispersion.

Furthermore, in accordance with this embodiment, it is preferred if the solution or dispersion comprises the solvent or dispersant in amounts of 20 to 70 wt %, in particular 25 to 65 wt %, preferably 30 to 60 wt. %, more preferably 35 to 50 wt. %, based on the solution or dispersion.

It is advantageously provided that the solution or dispersion contains the alloying reagent in amounts of 5 to 60 wt. %, in particular 10 to 45 wt. %, preferably 15 to 45 wt %, more preferably 20 to 40 wt. %, based on the solution or dispersion.

A further subject-matter of the present invention—according to a second aspect of the present invention—is a composition, in particular a precursor granulate, obtainable by the method described above.

The composition according to the invention, in particular the precursor granulate, is ideally suited for the production of silicon carbide-containing materials and in particular silicon carbide-containing objects.

The silicon carbide-containing materials or objects can thereby be produced either by additive manufacturing or also by vapor deposition, in particular chemical vapor deposition (CVD), whereby, for example, fibers and foams, but also crystalline silicon carbide-containing materials are accessible. Furthermore, it is also possible to use the composition, in particular the precursor granulate, for the production of electronics, such as anode materials or semiconductor materials in the chip industry.

In particular, the reduced composition described above, in particular the reduced precursor granulate, is suitable for applications in additive manufacturing. Due to the higher density of the reduced precursor granulate, it is much easier to obtain compact non-porous objects by means of additive manufacturing.

For all other applications, either the reduced or the non-reduced precursor granulate can be used, wherein the non-reduced precursor granulate will generally be used due to its ease of production and low energy input

For further details on the composition according to the invention, reference can be made to the above explanations on the method according to the invention.

A further subject-matter of the present invention—according to a third aspect of the present invention - is a liquid composition, in particular a suspension of a precursor granulate described above.

In the context of the present invention, it is not only possible to use the precursor granulate obtained in granular form, but it is equally possible to suspend the precursor granulate in a liquid, which is applied to substrates by means of printing processes, for example, and then to convert it into silicon carbide-containing objects. In the context of the present invention, a suspension is understood to be a dispersion in which a solid phase is present dispersed in a liquid phase.

When a liquid composition is used in the context of the present invention, it usually contains the precursor granulate in amounts of 5 to 60 wt. %, in particular 10 to 50 wt %, preferably 20 to 40 wt %, more preferably 25 to 35 wt. %, based on the liquid composition.

Now, with regard to the liquid phase of the liquid composition, this may be selected from all suitable organic solvents or water. Preferably, however, the liquid phase of the liquid composition is selected from alcohols, in particular ethanol, isopropanol or methanol, or acetone. Similarly, it may be provided that a thickening agent is added to the liquid composition, in particular in the liquid phase, to selectively adjust the viscosity.

By adjusting the viscosity, the liquid composition, in particular the suspension, can be applied in a suitable layer thickness.

The liquid composition according to the invention, in particular suspension, can be used in particular to expose layers of silicon carbide-containing materials, for example in wafer production, or for additive manufacturing by means of printing processes, in particular ink-jet processes. In this process, the liquid composition is applied to a substrate, at least in certain areas, and then converted to silicon carbide-containing materials at temperatures of 1,600° C. to 2,100° C.

For further details on the liquid composition, in particular suspension, according to the invention, reference can be made to the above explanations on further aspects of the invention.

Again, further subject-matter of the present invention - according to a fourth aspect of the present invention - is the use of a composition, in particular a precursor granulate for the production of silicon carbide-containing granules or for the production of silicon carbide-containing foams and/or fibers.

Methods for the production of electrode materials or also of fibers and foams are known in the prior art In this regard, reference is also made by way of example to DE 10 2014 116 868 A1, DE 10 2015 100 062 A1 or US 2010/2000595 A1.

For this type, in particular the non-reduced composition, in particular the non-reduced precursor granulate, can be used.

For further details on this use according to the invention, reference can be made to the above explanations on the further aspects of the invention.

Again, further subject-matter of the present invention—according to a fifth aspect of the present invention—is the use of a composition, in particular a precursor granulate, for the production of three-dimensional silicon carbide-containing objects.

With respect to further embodiments of the use according to the present invention, reference may be made to the above explanations of the other aspects of the invention, which apply accordingly with respect to the use according to the present invention.

The composition described above, in particular the precursor granulate, is ideally suited for additive manufacturing of silicon carbide-containing structures. Preferably, the composition, in particular the precursor granulate, is used in a method for the production of three-dimensional objects, in particular workpieces, from silicon carbide-containing compounds by means of additive manufacturing, wherein the silicon carbide-containing compounds are obtained from the composition, in particular the precursor granulate, by the selective, in particular site-selective, input of energy.

The method permits in particular the simple production of virtually any silicon carbide-containing materials—in particular also of non-stoichiometric silicon carbides through to silicon carbide-containing alloys for advanced ceramics.

The method also allows the generation of high-resolution and detailed three-dimensional structures, i.e. the course of edges is highly precise and in particular free of ridges. Within the scope of the method, it is furthermore possible to obtain compact solids which do not comprise a porous structure but consist of crystalline silicon carbide-containing materials. The materials and three-dimensional objects obtained by the method according to the invention thus possess almost the properties of crystalline silicon carbide compounds in terms of their material properties.

Furthermore, through the use of generative manufacturing processes, it is also possible to produce the three-dimensional structures in supported construction, in particular in a powder bed process. In this case, in particular, the composition not subjected to the action of energy, in particular laser radiation, can be further used, i.e. the method according to the invention can be carried out with virtually no undesirable residual materials. In particular, the method according to the invention allows very fast and low-cost production of three-dimensional silicon carbide-containing objects and, in particular, does not require the application of pressure in order to provide compact non-porous or low-porosity materials and materials.

In the context of additive manufacturing, the reaction to the target compounds can be carried out in a wide variety of ways. Advantageously, however, it is envisaged that the precursor compounds are cleaved under the action of energy, in particular under the action of a laser beam, and pass into the gas phase as reactive particles. Since silicon and carbon and, if necessary, doping or alloying elements are present in the immediate proximity in the gas phase due to the special composition of the precursor, the silicon carbide or the doped silicon carbide or silicon carbide alloy, which sublimates only above 2,300° C., precipitates. In particular, crystalline silicon carbide absorbs laser energy much more poorly than the precursor granules and conducts heat very well, so that a locally strictly limited deposition of the defined silicon carbide compounds takes place. Undesirable components of the precursor compound, on the other hand, form stable gases, such as CO₂, HCl, H₂O, etc., and can be removed via the gas phase.

Now, as far as process control is concerned, it has been well proven if the method is carried out under a protective gas atmosphere, in particular a nitrogen and/or argon atmosphere, preferably an argon atmosphere. The method according to the invention is generally carried out under a protective gas atmosphere so that, in particular, carbon-containing precursor compounds are not oxidized. If the method is carried out under an argon atmosphere, it is generally also an inert gas atmosphere, since argon does not react with the precursor compounds under the process conditions. If nitrogen is used as the inert gas, silicon nitrides in particular can also be formed. This may be desirable, for example, in the case of additional mixed doping of the silicon carbide with nitrogen.

However, if incorporation of nitrogen into the silicon carbide or into the silicon carbide-containing compound is not desired, the method according to the invention is carried out under an argon atmosphere.

Within the scope of the method, it is usually provided that the input of energy is carried out by means of radiant energy, in particular by laser radiation.

Now, as far as the resolution of the site-selectively introduced energy is concerned, it has been well proven if the input of energy, in particular by means of laser radiation, takes place with a resolution of 0.1 to 150 μm, in particular 1 to 100 μm, preferably 10 to 50 μm. In this way, the production of particularly high-contrast and sharply defined or detailed objects from the precursor granulate is possible. The resolution of the energy input, in particular of a laser beam, generally represents the lower limit of the resolving power for boundary surfaces and details of the manufactured object Alternatively, the input of energy can be locally limited by the use of masks. However, the use of laser beams is preferred. In this context, the resolution of the input of energy means in particular the minimum width of the area of the input of energy. It is usually limited by the cross-sectional area of the laser beam or dimensioning of the mask.

According to a preferred embodiment of the method, additive manufacturing is carried out using a method similar to Selective Laser Melting (SLM): Selective Synthetic Crystallization (SSC). In Selective Synthetic Crystallization, the production of an object is not from the melt, but from the gas phase. The apparatus set-up and implementation of

Selective Synthetic Crystallization correspond to Selective Laser Melting, i.e. the same apparatus can be used for Selective Synthetic Crystallization under very similar conditions as for Selective Laser Melting. By laser radiation, the energy required to bring the starting materials into the gas phase can be introduced into the precursor granulate.

According to a preferred embodiment of the method, the method is carried out as a multistage process. In this context, it is provided in particular that
(a) in a first method step, the composition, in particular the precursor granulate, is provided in the form of a layer, in particular a sheet,
(b) in a second method step following the first method step (a), the composition, in particular the precursor granulate, is converted by action of energy, in particular at least regionally, into a compound containing silicon carbide, so that a layer of the three-dimensional object is produced, and
(c) in a third method step following the second method step (b), a further layer, in particular a layer, of the composition, in particular of the precursor granulate, is applied to the layer of the composition, in particular of the precursor granulate, which was converted in the second method step (b), in particular at least in certain areas,
   wherein the method steps (b) and (c) are repeated until the three-dimensional object is completed. In particular, it is also intended that method step (b) is carried out after method step (c).

The method is thus carried out in particular as a so-called powder bed process, in which the three-dimensional object to be manufactured is produced layer-by-layer from a powder by selective input of energy. For the production of the three-dimensional object, a three-dimensional representation of the object to be produced is usually generated by means of computer technology, in particular as a CAD file, which is transferred to a corresponding layer attachment and then successively generated, i.e. layer by layer, by means of additive manufacturing, in particular by means of Selective Synthetic Crystallization. In this way, the finished three-dimensional object is finally obtained.

A special feature of the method is to be seen in particular in the fact that it does not require any subsequent sintering steps, i.e. in the context of the present invention, the precursors are selected and, in particular, adapted to the Selective Synthetic Crystallization in such a way that a homogeneous, compact three-dimensional body is obtained directly from the gas phase, which does not have to be subjected to sintering.

Now, as far as the provision of the composition, in particular the precursor granules, in the powder bed is concerned, this can be carried out with different layer thicknesses. Usually, however, a layer, in particular a film, of the composition comprises a thickness, in particular a film thickness, of 1 to 1,000 μm, in particular 2 to 500 μm, preferably 5 to 250 μm, more preferably 10 to 180 μm, particularly preferably 20 to 150 μm, very particularly preferably 20 to 100 μm. With thicknesses of the layers, in particular film thicknesses, in the ranges mentioned above for the composition, three-dimensional objects rich in detail can be produced with a high resolution.

According to an alternative embodiment of the invention, the additive manufacturing of the silicon carbide-containing object to be produced can take place on a substrate, for example a carrier plate or a complexly shaped body, which is later detached again from the silicon carbide-containing object Equally, however, the substrate can also consist of a workpiece to which the additively manufactured object subsequently remains firmly bonded. In this way, additional films and structures can be applied to existing objects using the method described here. In particular, workpieces made of materials with a relatively high melting point and with a material structure that ensures a relatively good bond with silicon carbide are suitable as substrates or existing objects. The most suitable substrate materials for these applications are silicon carbide and silicon carbide-containing compounds, ceramic materials and metals. In this way, for example, objects can be produced from silicon carbide alloys that comprise films with different properties, or films of silicon carbide-containing materials can be applied to metals, e.g. tool steel.

In order to apply precursors in a suitable manner to complex-shaped substrates and transform them there into silicon carbide-containing compounds, in particular with a laser, it can be provided in accordance with an embodiment of the present invention to selectively apply very small quantities of precursor granulate in a targeted manner using a suitable arrangement, in particular a granulate jet, in accordance with the method known in additive manufacturing with metals as “deposition welding” and to process them immediately with the laser.

The figures show according to

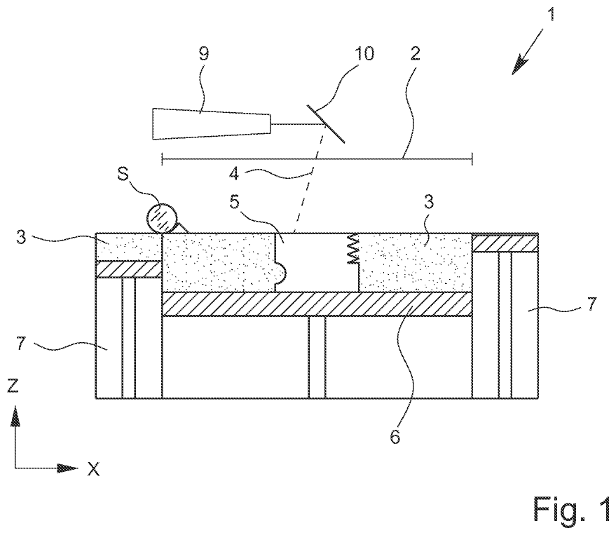

FIG. 1 a cross-section along an xy-plane of an apparatus for carrying out a method for the production of three-dimensional objects from the precursor granulate according to the invention, and

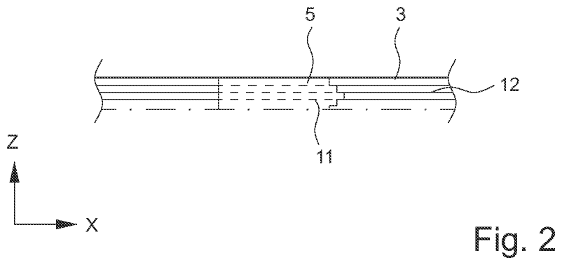

FIG. 2 an enlarged section of FIG. 1, which in particular shows the three-dimensional object produced.

The method is explained below on the basis of the representation of the figures by preferred embodiments in a non-limiting manner.

The apparatus 1 comprises a building field in an xy-plane, which is perpendicular to an xz-plane, the building field extension 2 of which is shown in the x-direction in FIG. 1. On the build field, a three-dimensional object is generated from a powdery composition 3, in particular a precursor granulate described above, by selective radiation of laser beams 4. The building field is configured to be movable by the piston 6 in the z-direction at least in certain areas, in particular along a z-axis which is perpendicular to the xy-plane. In the embodiment shown in the figure, the entire build field is configured to be movable by the piston 6 over its build field extension 2, in particular the entire extension of the build field in the x and y directions. However, it is also possible that according to an alternative embodiment not shown in the figure, only selected areas of the construction field are movable in the z-direction, i.e. along a z-axis. Areas of the construction field can thus be configured, for example, in the form of stamps, which in particular can be moved independently of one another in the z-direction, so that selected areas of the construction field can be moved in the z-direction.

The construction field shown in the figure comprises a powder bed of the composition 3 according to the invention, in particular of the precursor granulate according to the invention. Adjacent to the construction field, storage devices 7 are provided for receiving and dispensing the composition 3. According to the form of execution shown in the figure, the storage devices 7 are provided with pistons movable in the z-direction, in particular along a z-axis, so that by moving the piston in the z-direction either a space is created in the storage device 7 for receiving the composition 3 or the composition is pressed out of the storage device 7, in particular into the region of the construction field.

After being discharged from the storage device 7, the composition 3 is distributed in a homogeneous uniform film on the construction field by a distribution device 8, wherein excess composition 3 can always be received in an opposite storage device 7. The distribution device 8 is exemplarily shown in the figure representation in the form of a roller.

The apparatus 1 comprises means for generating laser beams, in which laser beams 4 are generated. The laser beams 4 can be deflected via deflection means 10, in particular at least one mirror arrangement, onto the construction field, so that the three-dimensional object 5 is obtained there.

When carrying out the method for the production of silicon carbide-containing three-dimensional objects, a thin film of the composition 3 is presented now on the construction field and then by selective site-resolved radiation of laser beams 4 generated in the means for generating laser beams 9 and deflected via the deflection means 10 is heated and melted or decomposed into its components, so that a layer of a silicon carbide-containing compound is obtained.

Subsequently, the build field area is lowered at least slightly with the aid of the piston 6 and further composition 3 is dispensed from a storage device 7, which is homogeneously distributed on the build field in the form of a thin film by the distribution device 8.

This forms a new layer of composition 3 which can then be irradiated. Excess composition 3 is taken up again in the opposite storage device 7.

Subsequently, by means of the laser beams 4, the film is irradiated and heated in a site-selective manner, whereby a new layer of the three-dimensional object 5 made of a silicon carbide-containing material is formed. By repeating these method steps, the three-dimensional object 5 is finally built up.

In FIG. 2, an enlarged section of the construction area is shown, and in particular the various layers 11 of silicon carbide-containing material which build up the three-dimensional object 5 are shown. The individual layers 11 are shown only to illustrate the present invention. The individual layers are usually not recognizable on the three-dimensional object 5, since homogeneous objects of silicon carbide-containing material are obtained by the method described.

The subject-matter of the present invention is illustrated below by the working examples in a non-limiting manner.

### WORKING EXAMPLES

1. Production of a Precursor Granulate Based on Silanes and Its Use

For the production of a precursor granulate, 67.1 g of invert sugar syrup solution with a sugar content of 72.2% is added to a mixture of 35 ml of demineralized water and 110 ml of ethanol (purity >99% with 1% methyl ethyl ketone as denaturant) and 8.70 g of anhydrous citric acid and is heated to 70° C. After the citric acid has dissolved, 100 ml of tetraethyl orthosilicate (tetraethoxysilane) is added over a period of 30 minutes at 70° C. with stirring.

After the citric acid has dissolved, 100 ml of tetraethyl orthosilicate (tetraethoxysilane) is added over a period of 30 minutes at 70° C. with stirring. The previously clear solution shows a weak opalescence.

After the solution is clear again, the solvent is quickly removed in vacuo (30 mbar).

A colorless dry granulate is formed, which can be adjusted to particle sizes between 2 cm and 100 μm by using different stirrers and adjusting the stirring speeds.

The colorless granules are suitable for a wide range of applications for the production of silicon carbide-containing materials, in particular silicon carbide granules, silicon carbide wafers, for the production of foams and fibers from silicon carbide by CVD (chemical vapor deposition) methods or also in additive manufacturing processes.

To obtain a reduced granulate with a higher density, the colorless granulate is heated to temperatures of 500 to 800° C. under inert gas and in a vacuum. A cocoa-colored to black granulate is obtained, the density of which is increased by about 10 to 20% compared with the colorless granulate described above, and which is referred to below as reduced granulate.

The reduced dark granules are excellently suited for additive manufacturing, in particular for powder bed processes such as selective synthetic crystallization or selective laser sintering described above. Likewise, the reduced dark granules can also be used in an excellent manner for material desposition methods, such as deposition welding.

2. Production of a Precursor Granulate Based on Pyrogenic Silicic Acid and Its Use

For the production of the precursor granulate, 67.1 g of invert sugar syrup solution with a sugar content of 72.2% is mixed with 140 ml of fully demineralized water and 27.1 g of fumed silica with an average particle size of 200 nm and is heated to 70° C. for 30 minutes with stirring. The water is then rapidly removed in vacuo (30 mbar).

A colorless dry granulate is obtained, which can be adjusted to particle sizes between 2 cm and 100 μm by using different stirrers and adjusting the stirring speeds.

The colorless granulate corresponds in its properties and uses to the precursor granulate described in 1.).

To obtain a reduced granulate with a higher density, the colorless granulate is heated to temperatures of 500 to 800° C. under inert gas and in vacuum. A cocoa-colored to black granulate is obtained, the density of which is increased by about 10 to 20% compared with the colorless granulate described above, and which is referred to below as reduced granond in all respects to the reduced granulate described under 1.).

Reference signs:

| | |
|---|---|
| 1 | Apparatus |
| 2 | Building field extension |
| 3 | Composition |
| 4 | Laser beam |
| 5 | Object |
| 6 | Piston |
| 7 | Storage device |
| 8 | Distribution device |
| 9 | Means for generating laser beams |
| 10 | Deflection means |
| 11 | Layer |

1. A method for the production of a silicon carbide precursor granulate, comprising:
(a) producing a solution or dispersion comprising:
(v) at least one silicon-containing compound,
(vi) at least one carbon-containing compound,
(vii) at least one solvent or dispersant, and
(viii) optionally doping and/or alloying reagents, and
(b) removing the solvent or dispersant.

2. The method according to claim 1, wherein in the second method step (b) a powdery composition is obtained.

3. The method according to claim 2, wherein the powdery composition comprises particle sizes selected from 1 μm to 1,000 μm, 0.5 μm to 500 μm, 1 μm to 200 μm, 10 μm to 100 μm, and 40 μm to 80 μm.

4. The method according to claim 1, wherein the silicon-containing compound is selected from silanes, silane hydrolysates, orthosilicic acid and mixtures thereof.

5. The method according to claim 4, wherein the silicon-containing compound is a silane selected from tetraalkoxysilanes, trialkoxyalkylsilanes, tetraethoxysilane, tetramethoxysilane, and triethoxymethylsilane.

6. The method according to claim 1, wherein in step (a), at least one of the components is heated to a temperature selected from 30 to 100° C., 40 to 80° C., and 50 to 70° C.

7. The method according to claim 1, wherein the solvent or dispersant is selected from water, organic solvents and mixtures thereof.

8. The method according to claim 7, wherein the solvent is an organic solvent selected from alcohols, esters, ketones, amines, amides, sulfoxides, methanol, ethanol, 2-propanol, acetone, ethyl acetate, N,N-dimethylformamide, dimethyl sulfoxide, and mixtures thereof.

9. The method according to claim 1, wherein the carbon-containing compound is selected from sugars, sucrose, glucose, fructose, invert sugar, maltose, starch, starch derivatives, organic polymers, phenol-formaldehyde resin, resorcinol-formaldehyde resin, and mixtures thereof.

10. The method according to claim 9, wherein the carbon-containing compound is selected from sugars, starch, starch derivatives and mixtures thereof.

11. The method according to claim 1, wherein the solution or dispersion further comprises at least one catalyst.

12. The method according to claim 11, wherein the catalyst is an acid or a base.

13. The method according to claim 1, wherein in step (b) the solvent or dispersant is removed at an elevated temperature and/or under reduced pressure.

14. The method according to claim 1, further comprising:
(c) thermally treating the composition obtained in step (b).

15. The method according to claim 14, wherein the composition in step (c) is heated to a temperature selected from 300 to 900° C., 400 to 800° C., and 500 to 700° C.

16. A silicon carbide precursor granulate prepared by the method of claim 1.

17. The precursor granulate of claim 16, which is in a liquid composition or, suspension.

18-19. (canceled)
